(19) United States
(12) Patent Application Publication
(10) Pub. No.: US 2019/0270859 A1
(43) Pub. Date: Sep. 5, 2019

(54) CROSSLINKED POLYOLEFIN RESIN FOAM

(71) Applicant: SEKISUI CHEMICAL CO., LTD., Osaka (JP)

(72) Inventors: Takumei UNO, Shiraoka-shi (JP); Yukihiro SUGIE, Shiraoka-shi (JP); Hiroki MIKAMI, Koga-shi (JP); Hajime TAKASUGI, Hasuda-shi (JP)

(73) Assignee: SEKISUI CHEMICAL CO., LTD., Osaka (JP)

(21) Appl. No.: 16/338,034

(22) PCT Filed: Sep. 29, 2017
(86) PCT No.: PCT/JP2017/035758

§ 371 Date: Mar. 29, 2019

(30) Foreign Application Priority Data
Sep. 30, 2016 (JP) 2016-194876

(51) Int. Cl. C08J 9/10; C08J 3/24; C08J 9/18

(52) U.S. Cl. CPC C08J 9/103; C08J 3/24; B60R 13/02; C08J 2323/16; C08J 2207/00; C08J 9/18

(57) ABSTRACT

The cross-linked polyolefin resin foam of the present invention is made by cross-linking and foaming a polyolefin resin composition comprising a polyolefin resin-containing resin (A), and a zeolite (B). The polyolefin resin composition includes 0.05 to 10 parts by mass of the zeolite (B) relative to 100 parts by mass of the resin (A) and the average particle diameter of the zeolite (B) is 0.1 to 30 μm. According to the present invention, a cross-linked polyolefin resin foam capable of suppressing the generation of an odor without use of a coloring component such as carbon black can be provided, allowing the foam to be continuously produced using an extruder or the like with high productivity.

### TECHNICAL FIELD

The present invention relates to a cross-linked polyolefin resin foam, a manufacturing method thereof, and a material for vehicle interiors made from the cross-linked polyolefin resin foam.

### BACKGROUND ART

Crosslinked polyolefin resin foam is generally excellent in flexibility, lightness and heat insulation, and widely used as a laminate with skin material, an insulating material, a cushioning material, and the like. In particular, in the automotive field, the foam is used as a material for vehicle interiors including a ceiling, a door, and an instrument panel.

The interior of an automobile is exposed to high temperature when the atmospheric temperature is high, for example, in summer. On this occasion, an odor generated from vehicle interior materials causes a problem in some cases. It is believed that the odor is generated by volatilization of a trace amount of decomposition residues contained in a resin foam for use as interior material due to exposure to a high-temperature environment.

In order to suppress the odor generated from the foam, for example, PTL1 discloses a polyolefin resin foam containing activated carbon as deodorant. Further, PTL2 discloses, as a foam capable of suppressing fogging and odor, a polyolefin resin foam containing carbon black in.

### CITATION LIST

### Patent Literature

PTL1: JP 11-60774 A

PTL2: JP 11-263863 A

### SUMMARY OF INVENTION

### Technical Problem

A polyolefin resin foam is continuously produced using an extruder in some cases, and, on this occasion, a screen mesh is used to remove foreign matters, debris, etc., in the resin composition. Since the material disclosed in PTL1 contains activated carbon having a large particle diameter, the screen mesh is clogged with the activated carbon, causing a problem of lowered productivity for the foam.

Further, since a polyolefin resin foam is used in applications requiring good design such as interior materials, the foam is required to be colorless in some cases, such that the flexibility of design can be secured in a later process. However, as disclosed in PTL2, use of carbon black as a deodorant makes a foam black, which causes a problem that a subsequent design is restricted. For example, in the case where the foam is used as a vehicle interior material, of which the surface is usually provided with an interior surface material, the appearance of the interior surface material reflects the black color of the foam through transmission, so that a desired appearance cannot be obtained in some cases.

It is an object of the present invention, in view of these circumstances, to provide a cross-linked polyolefin resin foam capable of suppressing the generation of an odor without use of a coloring component such as carbon black, allowing the foam to be continuously produced using an extruder or the like with high productivity.

### Solution to Problem

Through extensive investigation, the present inventors found that use of a specified amount of zeolite having a specific average particle diameter enables to suppress the generation of an odor without use of a coloring component such as carbon black, and allows the foam to be manufactured using an extruder or the like with high productivity. The present invention described below has been thus accomplished.

[1] A cross-linked polyolefin resin foam made by cross-linking and foaming a polyolefin resin composition comprising a polyolefin resin-containing resin (A) and zeolite (B),

the amount of the zeolite (B) included in the polyolefin resin composition being 0.05 to 10 parts by mass relative to 100 parts by mass of the resin (A), and

the zeolite (B) having an average particle diameter of 0.1 to 30 μm.

[2] The cross-linked polyolefin resin foam according to the above [1], wherein the polyolefin resin composition further comprises a thermally decomposable organic foaming agent.

[3] The cross-linked polyolefin resin foam according to the above [2], wherein the thermally decomposable organic foaming agent is azodicarbonamide.

[4] The cross-linked polyolefin resin foam according to the above [2] or [3], wherein the amount of the thermally decomposable organic foaming agent included in the polyolefin resin composition is 1 to 30 parts by mass relative to 100 parts by mass of the resin (A).

[5] The cross-linked polyolefin resin foam according to any one of above [1] to [4], wherein the resin (A) comprises 50 mass % or more of a polypropylene resin as the polyolefin resin.

[6] The cross-linked polyolefin resin foam according to the above [5], wherein the resin (A) further comprises 1 to 50 mass % of a polyethylene resin as the polyolefin resin.

[7] The cross-linked polyolefin resin foam according to any one of the above [1] to [6], wherein the foam has a density of 0.02 to 0.20 g/cm³.

[8] A material for vehicle interior further formed from the cross-linked polyolefin resin foam according to any one of the above [1] to [7].

[9] A method for manufacturing cross-linked polyolefin resin foams comprising extruding a polyolefin resin composition comprising a polyolefin resin-containing resin (A) and zeolite (B) with an extruder, and cross-linking and foaming the extruded polyolefin resin composition so as to obtain a cross-linked polyolefin resin foam,

the amount of the zeolite (B) included in the polyolefin resin composition being 0.05 to 10 parts by mass relative to 100 parts by mass of the resin (A), and

the zeolite (B) having an average particle diameter of 0.1 to 30 μm.

### Advantageous Effects of Invention

According to the present invention, a cross-linked polyolefin resin foam capable of suppressing the generation of an odor can be provided without use of a coloring component such as carbon black, allowing the foam to be continuously produced using an extruder or the like with high productivity.

### DESCRIPTION OF EMBODIMENTS

The present invention is further described in detail with reference to embodiments as follows.

[Cross-Linked Polyolefin Resin Foams]

The cross-linked polyolefin resin foam in the present invention (hereinafter referred to simply as “foam” in some cases) is made of a cross-linked and foamed polyolefin resin composition comprising a polyolefin resin-containing resin (A) and zeolite (B), (hereinafter referred to simply as “resin composition” in some cases). Each of the components contained in the resin composition is described in detail as follows.

<Resin (A)>

The resin (A) comprises a polyolefin resin. Examples of the polyolefin resin include a polypropylene resin and a polyethylene resin.

(Polypropylene Resin)

Examples of the polypropylene resin include a homopolypropylene which is a single polymer of propylene and a copolymer of propylene and an α-olefin other than propylene.

Examples of the copolymer of propylene and the α-olefin other than propylene include a block copolymer, a random copolymer, and a random block copolymer, and in particular, a random copolymer (i.e. random polypropylene) is preferred.

Examples of the α-olefin other than propylene include ethylene having 2 carbon atoms, an α-olefin having about 4 to 10 carbon atoms such as 1-butene, 1-pentene, 1-hexene, 4-methyl-1-pentene, 1-heptene, and 1-octene. In particular, ethylene is preferred from the viewpoint of formability and heat resistance. In a copolymer, the α-olefins may be used singly or two or more may be used in combination.

The polypropylene resins may be used singly or two or more may be used together.

Preferably, the random polypropylene is obtained by copolymerizing propylene in an amount of 50 mass % or more and less than 100 mass % and an α-olefin other than propylene in an amount of 50 mass % or less. Relative to the total monomer components to constitute a copolymer, a content of propylene of 80 to 99.9 mass % and a content of an α-olefin other than propylene of 0.1 to 20 mass % are more preferred, a content of propylene of 90 to 99.5 mass % and a content of an α-olefin other than propylene of 0.5 to 10 mass % are still more preferred. Further, it is more preferable that the content of propylene is 95 to 99 mass % and the content of α-olefin other than propylene is 1 to 5 mass %, relative to the total amount of monomer components to constitute the copolymer.

The polypropylene resin is preferably a random polypropylene, or may be a mixture of a homopolypropylene and a random polypropylene.

(Polyethylene Resin)

Examples of the polyethylene resin include a low-density polyethylene resin, a medium-density polyethylene resin, a high-density polyethylene resin, a linear low-density polyethylene resin. In particular, a linear low-density polyethylene resin (LLDPE) is preferred.

The linear low-density polyethylene resin is a polyethylene having a density of 0.910 g/cm³ or more and less than 0.950 g/cm³, preferably 0.910 g/cm³ to 0.930 g/cm³.

A foam containing a linear low-density polyethylene resin with a low density tends to have improved processability in processing the resin composition into a foam and improved formability in forming the foam into a formed product. The density of the resin described above was measured in accordance with JIS K7112.

The linear low-density polyethylene resin is typically a copolymer of ethylene as main component (50 mass % or more relative to the total monomers, preferably 70 mass % or more, more preferably 90 mass % or more) and a small amount of α-olefin. The α-olefin has preferably 3 to 12 carbon atoms, more preferably 4 to 10 carbon atoms, and specific examples thereof include 1-butene, 1-pentene, 1-hexene, 4-methyl-1-pentene, 1-heptene, and 1-octene. In a copolymer, the α-olefins may be used singly or two or more may be used in combination.

The polyethylene resins may be used singly or two or more may be used together.

The resin (A) may further comprise a polyolefin resin component other than the resins described above.

Specific examples of the resin component include an ethylene-propylene rubber (EPR), an ethylene-propylene-diene rubber (EPDM), an ethylene-vinyl acetate copolymer, an ethylene-acrylic acid copolymer, an ethylene-alkyl (meth)acrylate copolymer, and a modified copolymer of maleic anhydride copolymerized therewith.

The resin (A) may consist of a polyolefin resin alone, or may comprise a resin component other than the polyolefin resin within the range not impeding the object of the present invention.

The content of the polyolefin resin is typically 70 mass % or more, preferably 80 to 100 mass %, more preferably 90 to 100 mass %, relative to the total amount of the resin (A).

The resin (A) contains the polypropylene rein preferably in an amount of 50 mass % or more, more preferably in an amount of 55 to 90 mass %. A foam containing the polypropylene resin as main component of the resin (A) can have improved mechanical strength, heat resistance, and the like.

The resin (A) preferably further comprises the polyethylene resin in addition to the polypropylene resin preferably in an amount of 1 to 50 mass %, more preferably 10 to 45 mass %. The resin composition comprising the polyethylene resin tends to have improved processability and formability with enhanced mechanical strength, heat resistance, etc.

<Zeolite (B)>

The resin composition for use in the present invention comprises zeolite as the component (B).

Zeolite is a generic term given to crystalline porous aluminosilicates, represented by the following general formula (1) usually in the form of a hydrate:

M_{2/n}O.Al₂O₃.xSiO₂.yH₂O (1)

wherein M represents a metal cation, n represents the valence of the metal cation M, x represents a number of 2 or more, and y represents a number of 0 or more.

Zeolite includes tetrahedron-structured SiO4 and A104 as basic structural units, which are three-dimensionally connected to each other to form a crystal having pores (voids). Water of crystallization (occluded water) or cations are introduced into the voids, so that the adsorption properties of zeolite can be adjusted by ion exchange or dehydration on an as needed basis.

It is presumed that the resin composition for use in the present invention comprises zeolite (B), so that decomposition residues to cause an odor are adsorbed to zeolite, and thereby the generation of an odor can be suppressed.

The zeolite (B) may be a natural zeolite or a synthesized zeolite. Examples of the natural zeolite include analcite, chabazite, erionite, natrolite, mordenite, clinoptilolite, heulandite, stilbite and laumontite.

Examples of the synthesized zeolite include an A-type zeolite, an X-type zeolite, a Y-type zeolite, an L-type zeolite and ZSM-5.

In particular, a synthesized zeolite is preferred, and an A-type zeolite is more preferred from the viewpoints of handling properties, shape selectivity, etc.

These zeolites (B) may be used singly or may be used in combination of two or more.

Synthesized zeolites are commercially available as a molecular sieve for use as an adsorbent. Molecular sieves are usually classified into 3 A (pore size: 3 angstrom), 4 A (pore size: 4 angstrom), 5 A (pore size: 5 angstrom), 13X (pore size: 10 angstrom), etc., depending on the pore diameter, and it is preferred that the sieve be appropriately selected therefrom in consideration of the effect to suppress the odor.

Molecular sieves are commercially available, and examples thereof include “MOLECULAR SIEVE 3A”, “MOLECULAR SIEVE 4A”, “MOLECULAR SIEVE 5A” and “MOLECULAR SIEVE 13X” manufactured by Union Carbide Corporation.

The pore diameter of the zeolite (B) may be typically 1 to 20 angstrom, 2 to 15 angstrom, or 2 to 10 angstrom, though not particularly limited. The pore diameter can be measured by a known method, i.e., a constant-volume gas adsorption method.

The zeolite (B) has an average particle diameter of 0.1 to 30 μm from the viewpoint of the productivity for the foam. With the average particle diameter within the range, even when the foam is manufactured using an extruder or the like, a screen mesh is prevented from being clogged with the zeolite, so that an excellent productivity can be achieved. From the same viewpoint, the zeolite (B) has an average particle diameter of preferably 0.2 to 15 μm, more preferably 0.3 to 10 μm.

The average particle diameter of the zeolite (B) is a value measured by a laser diffraction method, meaning a particle diameter (D₅₀) corresponding to a cumulative frequency of 50%.

The amount of the zeolite (B) included in the resin composition is 0.05 to 10 parts by mass, preferably 0.5 to 9 parts by mass, more preferably 1 to 8 parts by mass, relative to 100 parts by mass of the resin (A) from the viewpoint of suppressing the odor sufficiently and achieving the improved foaming properties.

Although the resin composition used in the present invention may contain a deodorant other than the zeolite (B) within a range not impairing the effect of the present invention, it is preferred that activated carbon, carbon black, etc., are not contained from the viewpoint of preventing coloration.

<Additive>

The resin composition for use in the present invention typically contains a foaming agent as an additive other than the resin components described above. Further, it is preferred that one or both of a cross-linking aid and an antioxidant are contained.

(Foaming Agent)

Methods for foaming a resin composition include a chemical foaming method and a physical foaming method. The chemical foaming method is a method for forming bubbles of gas generated by thermal decomposition of a compound added to the resin composition, and the physical foaming method is a method for forming cells by impregnating the resin composition with a liquid having a low-boiling point (foaming agent) and then volatilizing the foaming agent. Although the foaming method is not particularly limited, the chemical foaming method is preferred from the viewpoint of obtaining a uniform closed cell foam.

A thermally decomposable foaming agent is used as the foaming agent. For example, a thermally decomposable organic foaming agent or a thermally decomposable inorganic foaming agent having a decomposition temperature of about 160 to 270° C. can be used.

Examples of the thermally decomposable organic foaming agent include an azo compound such as azodicarbonamide, a metal azodicarboxylate (barium azodicarboxylate, or the like) and azobisisobutyronitrile; a nitroso compound such as N,N′-dinitrosopentamethylene tetramine; a hydrazine derivative such as hydrazodicarbonamide, 4,4′-oxybis (benzene sulfonyl hydrazide) and toluene sulfonyl hydrazide; and a semicarbazide compound such as toluene sulfonyl semicarbazide.

Examples of the thermally decomposable inorganic foaming agent include ammonium acid, sodium carbonate, ammonium hydrogen carbonate, sodium hydrogen carbonate, ammonium nitrite, sodium borohydride, and anhydrous monosodium citrate.

Among them, from the viewpoint of obtaining fine cells, and from the viewpoint of economic efficiency and safety, a thermally decomposable organic foaming agent is preferred; an azo compound and a nitroso compounds are more preferred; and an azo compound such as azadicarbonamide and azobisisobutyronitrile is still more preferred; and an azodicarbonamide is still more preferred.

The zeolite (B) contained in the foam of the present invention is excellent in adsorption capacity particularly to a substance to be adsorbed such as an organic compound and a decomposition product thereof, so that in the case where an organic foaming agent such as an azo compound is used as the foaming agent, the odor suppression effect of the present invention is more effectively exhibited.

These foaming agents may be used singly or may be used in combination of two or more.

The amount of the thermally decomposable organic foaming agent added in the resin composition is preferably 2 to 20 parts by mass, more preferably 3 to 12 parts by mass, relative to 100 parts by mass of the resin (A). With an amount of the thermally decomposable organic foaming agent in the range, the foaming properties of a foamable polyolefin resin sheet is improved, so that a cross-linked polyolefin resin foam sheet having a desired foaming ratio can be obtained.

(Cross-Linking Aid)

For example, a polyfunctional monomer can be used as a cross-linking aid. Examples of the polyfunctional monomer include a trifunctional (meth)acrylate compound such as trimethylolpropane trimethacrylate and trimethylolpropane triacrylate; a compound having three functional groups in a molecule such as triallyl trimellitate, 1,2,4-benzene triallyl tricarboxylate, and triallyl isocyanurate; a difunctional (meth)acrylate compound such as 1,6-hexanediol dimethacrylate, 1,9-nonanediol dimethacrylate, 1,10-decanediol dimethacrylate and neopentyl glycol dimethacrylate; a compound having two functional groups in a molecule such as divinylbenzene; diallyl phthalate, diallyl terephthalate, diallyl isophthalate, ethyl vinyl benzene, lauryl methacrylate and stearyl methacrylate. These cross-linking aids may be used singly or may be used in combination of two or more. Among them, tri-functional (meth)acrylate compound is preferred.

The addition of a cross-linking aid to a resin composition allows the resin composition to be cross-linked with a smaller dose of ionizing radiation. As a result, the individual resin molecule is prevented from being cut or deteriorated by the exposure to ionizing radiation.

The amount of cross-linking aid included in the resin composition is preferably 0.2 to 10 parts by mass, more preferably 0.5 to 7 parts by mass, still more preferably 1 to 5 parts by weight, relative to 100 parts by mass of the resin (A). With a content of 0.2 parts by mass or more, the resin composition is easily controlled to a desired cross-linking degree during foaming. With a content of 10 parts by mass or less, the cross-linking degree to be imparted to a resin composition can be easily controlled.

(Antioxidant)

Examples of the antioxidant include a phenol antioxidant, a sulfur antioxidant, a phosphorus antioxidant, an amine antioxidant. Among them a phenol antioxidant and a sulfur antioxidant are preferred, and use of a combination of a phenol antioxidant and a sulfur antioxidant is more preferred.

Examples of the phenol antioxidant include 2,6-di-tert-butyl-p-cresol, n-octadecyl-3-(3,5-di-tert-butyl-4-hydroxypheny0propionate, 2-tert-butyl-6-(3-tert-butyl-2-hydroxy-5-methylbenzyl)-4-methylphenylacrylate, tetrakis[methylene-3-(3,5-di-tert-butyl-4-hydroxyphenyl)propionate]methane. These phenol antioxidants may be used singly or may be used in combination of two or more.

Examples of the sulfur antioxidant include dilauryl thiodipropionate, dimyristyl thiodipropionate, distearyl thiodipropionate, pentaerythrityl tetrakis(3-lauryl thiopropionate). These sulfur antioxidants may be used singly or may be used in combination of two or more.

The amount of the antioxidant included in the resin composition is preferably 0.1 to 10 parts by mass, more preferably 0.2 to 5 parts by mass, relative to 100 parts by mass of the resin (A).

On an as needed basis, the resin composition may contain an additive other than the above-described ones such as an agent for adjusting decomposition temperature such as zinc oxide, zinc stearate and urea, a flame retardant, a metal toxicity inhibitor, an antistatic agent, a stabilizer, a filler, and a pigment.

The foam of the present invention is made by cross-linking and foaming the resin composition described above. The cross-linking degree of the foam is preferably 30 to 55 mass %, more preferably 40 to 50 mass %. With a cross-linking degree of a foam in the above range, the mechanical strength, flexibility and formability can be improved in a balanced manner. The method for measuring the cross-linking degree of a foam is described in Examples as follows.

Although the shape of the foam is not particularly limited, a sheet form is preferred. The thickness of a foam is preferably 0.5 to 10 mm, more preferably 0.8 to 8 mm. The foam having such a thickness can be appropriately formed into materials for vehicle interior.

The density (apparent density) of a foam is preferably 0.02 to 0.20 g/cm³, more preferably 0.03 to 0.15 g/cm³, for the improvement of flexibility and strength in a balanced manner.

Although the foam of the present invention may be colored on an as needed basis, from the viewpoint of enhancing the flexibility of the design, preferably the foam has no color, more preferably a natural color.

From the same viewpoint, the foam of the present invention has an L* defined in JIS Z 8730 of preferably 50 to 100, more preferably 60 to 100.

[Method for Manufacturing Cross-Linked Polyolefin Resin Foam]

The method for manufacturing a foam in an embodiment of the present invention includes extruding a resin composition containing at least the component (A) and component (B) with an extruder, and cross-linking and foaming the resin composition extruded so as to obtain a cross-linked polyolefin resin foam. Specifically, the present manufacturing method preferably includes the following steps (1) to (3).

Step (1): A step of supplying the component (A) and component (B), and other additives mixed on an as needed basis to an extruder so as to be melt-kneaded, and then extruding the resin composition in a predetermined shape such as in a sheet form from the extruder.

Step (2): A step of irradiating the resin composition obtained in the step (1) with ionizing radiation so as to cause cross-linking.

Step (3): A step of obtaining a foam by foaming the resin composition cross-linked in the step (2).

Examples of the extruder for use in the present manufacturing method include a single screw extruder and a twin screw extruder. Preferably, these extruders are equipped with a screen mesh from the viewpoint of removal of foreign matters, debris, etc., in the resin composition. The mesh size of the screen mesh is preferably 80 mesh or more, more preferably 150 mesh or more, from the viewpoint of uniformed quality of the resulting foam, though not particularly limited. The upper limit of the mesh size is, for example, 280 mesh or less, which may be appropriately determined considering the productivity.

The resin temperature inside the extruder is preferably 130 to 195° C., more preferably 160 to 195° C.

Examples of the ionizing radiation for use in the step (2) include α ray, β ray, and γ ray, and electron beam. Among them, electron beam is preferred. The dose of irradiation of the ionizing radiation is preferably 0.1 to 10 Mrad, more preferably 0.2 to 5 Mrad, though not particularly limited as long as a desired cross-linking degree can be obtained. Since the progress of cross-linking caused by exposure to ionizing radiation is affected by the composition of the resin composition, the dose of irradiation is typically controlled while measuring the cross-linking degree.

In the present manufacturing method, mixing of a thermally decomposable foaming agent as the foaming agent into the resin composition is preferred. In the case where a thermally decomposable foaming agent is contained, the heating temperature for foaming of the cross-linked resin composition in the step (3) is preferably a temperature equal to or more than the decomposition temperature of the thermally decomposable foaming agent. Specifically, the heating temperature is typically 200 to 290° C., preferably 220 to 280° C.

In the step (3), the foam may be stretched in one or both of the MD direction and the CD direction during or after foaming.

The manufacturing method described above is according to an embodiment of the present invention, and the foam may be manufactured by another manufacturing method.

<Formed Product>

In the present invention, the foam alone or the foam laminated with a different material on an as needed basis is preferably formed to a formed product by a known method. Examples of the forming method include vacuum forming, compression molding and stamping. Among them, vacuum forming is preferred. The vacuum forming includes forming over a male mold and forming in a female mold. The vacuum forming in a female mold is preferred. Examples of the different material include a product in a sheet form such as a resin sheet, a thermoplastic elastomer sheet, and fabric.

The formed product may be used in various applications, and is preferably used as an interior material for vehicles such as a ceiling material, a door, and an instrument panel.

### EXAMPLES

The present invention is further described in detail with reference to Examples as follows. The present invention is not limited to Examples, though.

The method for measuring each of the physical properties and the method for evaluating a foam are as follows.

(1) Cross-Linking Degree

A test piece of about 100 mg was sampled from a foam. The mass A (mg) of the test piece was accurately measured. Subsequently the test piece was immersed in 30 cm³ of xylene at 120° C. and left standing for 24 hours. The test piece was then filtered with a 200-mesh metal screen, and insoluble components on the metal mesh were sampled and vacuum-dried. The mass B (mg) of the insoluble components was accurately measured. From the measured value, the cross-linking degree (mass %) was calculated based on the following formula.

Cross-linking degree (mass %)=100×(B/A)

(2) Density

The density (apparent density) of a foam was as measured in accordance with JIS K 7222.

(3) Thickness of Foam

A dial gauge was used for the measurement.

(4) Odor Level

A test piece of 10 g was sampled from each of the foams obtained in Examples and Comparative Examples. The test piece was put in a glass container having a volume of 1 L, and evaluated on the odor after storage at 80° C. for 2 hours. According to the following sensory criteria, the odor was graded individually by five persons, and the value obtained by rounding off the average of the grades to the nearest integer was regarded as the odor level. The results are shown in Table 1.

1: No odor was present.

2: Slight odor was present.

3: Strong odor was present.

(5) Presence or Absence of Color

Each of the foams obtained in Examples and Comparative Examples was visually observed whether any color was present or not, and a colorless foam was evaluated as “A”, and a colored foam was evaluated as “B”. The results are shown in Table 1.

(6) Extrudability

In Examples and Comparative Examples, a foam that involved no clogging in the screen mesh (120 mesh) installed on a single screw extruder was evaluated as “A”, and a foam that involved clogging was evaluated as “B”. The occurrence of clogging in the screen mesh was confirmed by the load on the extruder. The results are shown in Table 1.

(7) Foaming Properties

Each appearance of the foams obtained in Examples and Comparative Examples was visually observed, and a foam having a foaming ratio equivalent to that of the foam in Comparative Example 1 with no addition of zeolite was evaluated as “A”, and a foam having a foaming ratio far lower than that of the foam in Comparative Example 1 was evaluated as “B”. The results are shown in Table 1.

Examples 1 to 4 and Comparative Examples 1 to 4 In each of the Examples and Comparative Examples, the resin components in parts by mass shown in Tables 1 were supplied to a single-screw extruder having a screen mesh (120 mesh), melt-kneaded at a resin temperature of 190° C., and extruded to obtain a resin composition in a sheet form with a thickness of 2.0 mm. Both surfaces of the resin composition in a sheet form were irradiated with electron beams at an acceleration voltage 800 kV with an irradiation dose of 1 Mrad to cross-link the resin composition. Then, the cross-linked resin composition was heated for foaming in an oven at 250° C. for 5 minutes to produce a foamed sheet (foam) with a thickness of 4 mm. The evaluation results of the foam in each of the Examples and Comparative Examples are shown in Table 1.

### [Table 1]

TABLE 1

| | | Example | | | | Comparative Example | | | |
|---|---|---|---|---|---|---|---|---|---|
| | | 1 | 2 | 3 | 4 | 1 | 2 | 3 | 4 |
| Composition | Random PP | 70 | 70 | 70 | 70 | 70 | 70 | 70 | 70 |
| (part by mass) | LLDPE | 30 | 30 | 30 | 30 | 30 | 30 | 30 | 30 |
| | Cross-linking aid | 3 | 3 | 3 | 3 | 3 | 3 | 3 | 3 |
| | Foaming agent | 8.5 | 8.5 | 8.5 | 8.5 | 8.5 | 8.5 | 8.5 | 8.5 |
| | Antioxidant 1 | 0.3 | 0.3 | 0.3 | 0.3 | 0.3 | 0.3 | 0.3 | 0.3 |
| | Antioxidant 2 | 0.3 | 0.3 | 0.3 | 0.3 | 0.3 | 0.3 | 0.3 | 0.3 |
| | Zeolite 1 | 2.5 | 5 | 8 | | | 15 | | |
| | Zeolite 2 | | | | 5 | | | | |
| | Zeolite 3 | | | | | | | | 5 |
| | Carbon black | | | | | | | 5 | |
| Average particle diameter of zeolite | | 4 | 4 | 4 | 4 | — | 4 | — | 75 |
| (D₅₀) (μm) | | | | | | | | | |
| Foam | Cross-linking degree | 45 | 45 | 45 | 45 | 45 | 45 | 45 | 45 |
| | (mass %) | | | | | | | | |
| | Density (g/cm³) | 0.056 | 0.056 | 0.056 | 0.056 | 0.056 | 0.091 | 0.056 | 0.056 |
| | Odor level | 2 | 1 | 1 | 2 | 3 | — | 2 | — |
| | Presence/absence of | A | A | A | A | A | — | B | — |
| | color (visual observation) | | | | | | | | |
| | Extrudability | A | A | A | A | A | A | A | B |
| | Foaming properties | A | A | A | A | A | B | A | — |
| | (visual observation) | | | | | | | | |

* In the table, “—” represents no evaluation due to no availability of a foam in good condition.

The details of each of the components in Table 1 are as follows.

Random PP: ethylene-propylene random copolymer, product name: EG7F, manufactured by Japan Polypropylene Corporation, MFR=1.3 g/10 min, ethylene content: 3 mass %

LLDPE: linear low-density polyethylene, product name: 5220G, manufactured by The Dow Chemical Company, Japan, density: 0.915 g/cm³.

Cross-linking aid: trimethylol propane trimethacrylate

Foaming agent: Azodicarbonamide

Antioxidant 1: 2,6-di-tert-butyl-p-cresol

Antioxidant 2: dilauryl thiodipropionate

Zeolite 1: “MOLECULAR SIEVE 3A” manufactured by Union Carbide Corporation, average particle diameter (D₅₀): 4 μm

Zeolite 2: “MOLECULAR SIEVE 4A” manufactured by Union Carbide Corporation, average particle diameter (D₅₀): 4 μm

Zeolite 3: “Synthesized zeolite A-3” manufactured by Wako Pure Chemical Industries, Ltd., average particle diameter (D₅₀): 75 μm (product passing through 200-mesh)

Carbon black: “ASAHI #60” manufactured by Asahi Carbon Co., Ltd., average particle diameter: 45 nm

In Examples 1 to 4, due to a specified amount of the zeolite (B) with a small particle diameter mixed, cross-linked polyolefin resin foams capable of suppressing the generation of an odor without use of a coloring component such as carbon black were obtained with high productivity.

In contrast, in Comparative Example 1, the suppression of odor was insufficiently achieved due to zero amount of the zeolite (B) mixed. In Comparative Example 2, the foaming properties worsened due to an excessive amount of the zeolite (B) mixed. In Comparative Example 3, coloring was confirmed due to the use of carbon black, and in Comparative Example 4, the extrudability worsened due to the use of zeolite having an average particle diameter of more than 30 μm.

1. A cross-linked polyolefin resin foam made by cross-linking and foaming a polyolefin resin composition comprising a polyolefin resin-containing resin (A) and zeolite (B),
the amount of the zeolite (B) included in the polyolefin resin composition being 0.05 to 10 parts by mass relative to 100 parts by mass of the resin (A), and
the zeolite (B) having an average particle diameter of 0.1 to 30 μm.

2. The cross-linked polyolefin resin foam according to claim 1, wherein the polyolefin resin composition further comprises a thermally decomposable organic foaming agent.

3. The cross-linked polyolefin resin foam according to claim 2, wherein the thermally decomposable organic foaming agent is azodicarbonamide.

4. The cross-linked polyolefin resin foam according to claim 2, wherein the amount of the thermally decomposable organic foaming agent included in the polyolefin resin composition is 2 to 20 parts by mass relative to 100 parts by mass of the resin (A).

5. The cross-linked polyolefin resin foam according to claim 1, wherein the resin (A) comprises 50 mass % or more of a polypropylene resin as the polyolefin resin.

6. The cross-linked polyolefin resin foam according to claim 5, wherein the resin (A) further comprises 1 to 50 mass % of a polyethylene resin as the polyolefin resin.

7. The cross-linked polyolefin resin foam according to claim 1, wherein the foam has a density of 0.02 to 0.20 g/cm³.

8. A material for vehicle interior obtained by forming of the cross-linked polyolefin resin foam according to claim 1.

9. A method for manufacturing cross-linked polyolefin resin foams comprising extruding a polyolefin resin composition comprising a polyolefin resin-containing resin (A) and zeolite (B) with an extruder, and cross-linking and foaming the extruded polyolefin resin composition so as to obtain a cross-linked polyolefin resin foam,
the amount of the zeolite (B) included in the polyolefin resin composition being 0.05 to 10 parts by mass relative to 100 parts by mass of the resin (A), and
the zeolite (B) having an average particle diameter of 0.1 to 30 μm.
